(19) United States
(12) Patent Application Publication
(10) Pub. No.: US 2003/0007265 A1
(43) Pub. Date: Jan. 9, 2003

(54) Vehicle rear view mirror

(76) Inventor: Timothy Hugh Norman, Isles of Scilly (GB)

Correspondence Address: BIERMAN MUSERLIAN AND LUCAS, 600 THIRD AVENUE, NEW YORK, NY, 10016

(21) Appl. No.: 10/018,538

(22) PCT Filed: Apr. 2, 2001
(86) PCT No.: PCT/GB01/01503

(30) Foreign Application Priority Data
Apr. 14, 2000 (GB) 0009333.6

(51) Int. Cl. A47G 1/16; A47F 7/14; G02B 5/10; G02B 7/182

(52) U.S. Cl. 359/871; 359/868; 248/475.1

(57) ABSTRACT

A vehicle rear view mirror comprising a housing (1), a mirror lens and a location frame (3), said frame (3) being adapted to carry said mirror lens and to locate within said housing (1).

This invention relates to a vehicle rear view mirror. In known types of rear view mirrors the mirror lens is usually carried directly on a housing which includes means to mount the mirror in position.

There are disadvantages with the constructions referred to above due to the ease with which the mirror can be broken if the mounting becomes distorted. It can also be difficult to locate the mirror in position without some form of bead or retaining element.

The present invention is intended to overcome the difficulties referred to above and to provide a construction which is easy to assemble and which can be easily dismantled to replace a mirror lens in the housing if required.

According to the present invention a vehicle rear view mirror comprises a housing, a mirror lens and a location frame, said frame being adapted to carry said mirror lens and to locate within said housing.

Thus, due to the mirror lens being carried in the frame, it is easier to fit into the housing and the possibilities of damage to the mirror lens during fitting is reduced.

Preferably the frame is located within a rim of the housing and the frame can be a resilient snap fit.

In a preferred construction the frame is provided with engagement means to resiliently engage retaining means on the housing.

Thus, the engagement means may comprise one or more abutments adapted to locate behind one or more co-operating catches which provide said retaining means on the housing.

Preferably the abutments and/or the catches are resilient.

The mirror lens can be a resilient snap fit in the frame and the frame can be provided with one or more inner abutments adapted to retain the mirror lens in place.

The frame and/or housing can be made from any convenient material, for example metal or a synthetic plastics material.

Preferably the housing is provided by a casing which covers the rear face of the mirror lens and which is provided with means to receive a mounting.

The mirror lens can be any convenient shape, for example concave, convex or flat and is conveniently of the polycarbonate unbreakable type or glass.

The invention can be performed in various ways but one embodiment will now be described by way of example and with reference to the accompanying drawings in which:

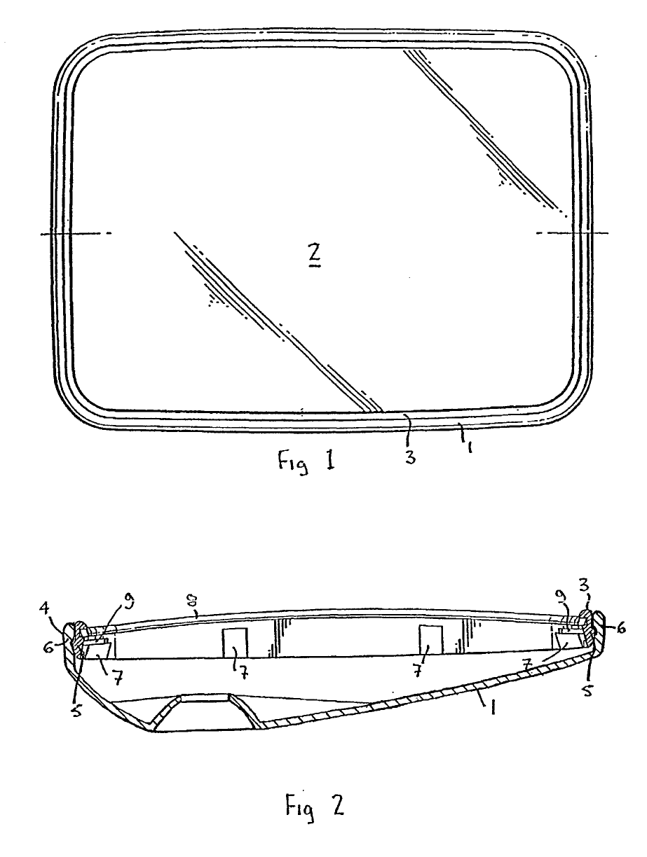

FIG. 1 is a plan view from above of the vehicle rear view mirror according to the invention;

FIG. 2 is a cross-sectional side elevation of the mirror shown in FIG. 1 but with the mirror lens removed for clarity;

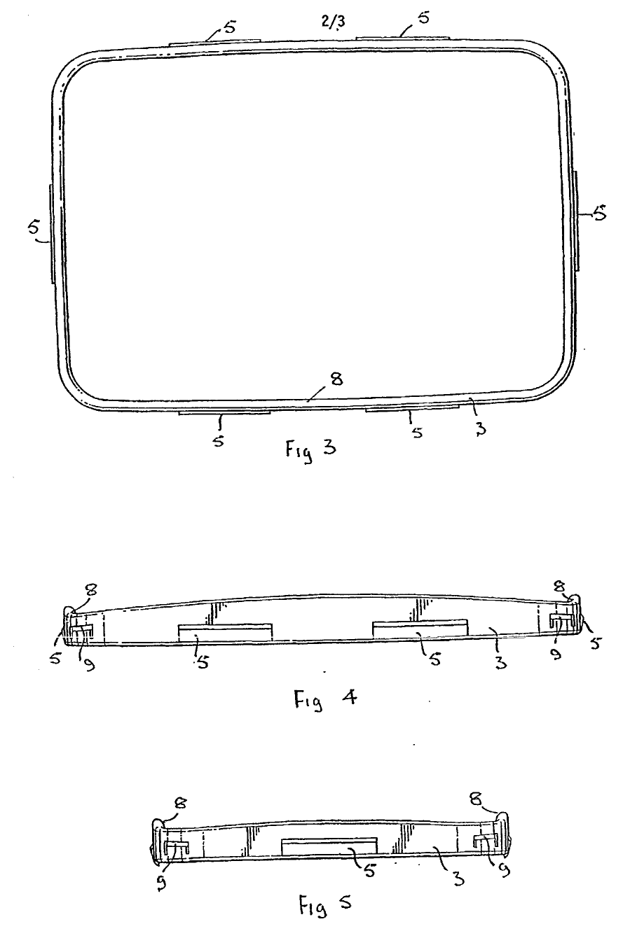

FIG. 3 is a plan view from above of the mirror frame employed in the construction;

FIG. 4 is a side elevation of the mirror frame shown in FIG. 3;

FIG. 5 is an end elevation of the mirror frame shown in FIGS. 3 and 4;

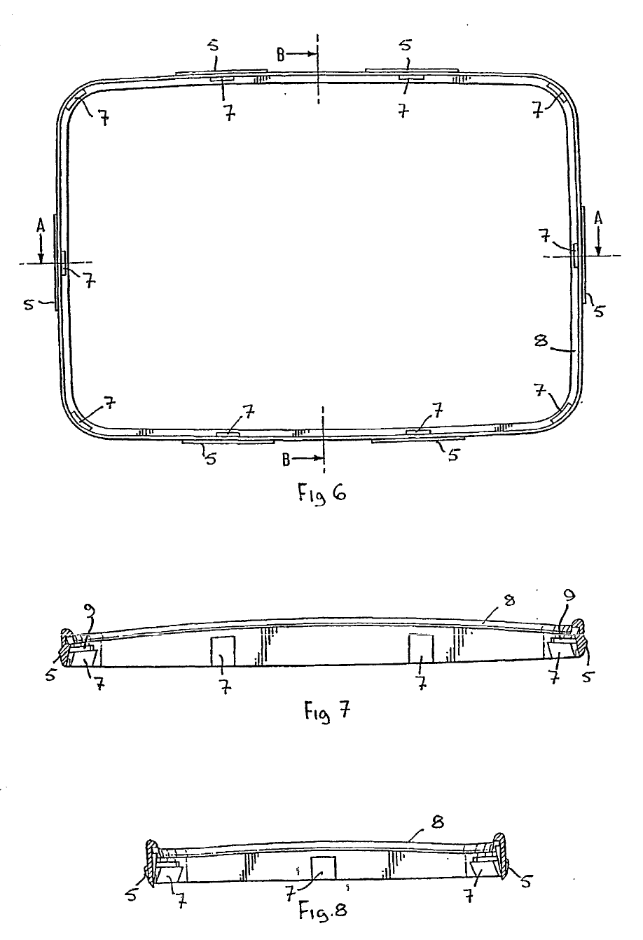

FIG. 6 is a plan view from below of the mirror frame shown in FIG. 3;

FIG. 7 is a cross-sectional side elevation of the mirror frame on the line A-A of FIG. 6; and,

FIG. 8 is a cross-sectional end elevation on the line B-B of FIG. 6.

As shown in the drawings a vehicle rear view mirror according to the present invention comprises a housing in the form of a casing 1 and mirror lens 2, which is only shown in FIG. 1, and a frame 3 which is adapted to carry the mirror lens 2 and locate it within the casing 1.

The casing has a rim portion 4 within which the frame 3 is located and the frame is a resilient snap fit in the casing 1.

The frame 3 is provided with engagement means to resiliently engage retaining means in the casing 1, these engagement means comprising one or more abutments 5 which are adapted to locate behind one or more co-operating catches 6 which provide the retaining means on the casing 1.

If desired the abutments and catches could be provided as continuous ridges on the frame and casing but, as shown in the drawings, a series of abutments and catches can be provided. In the construction shown a single abutment and catch are provided at transverse ends of the frame and casing and two abutments and catches are provided on each of the sides.

The frame 3 and/or casing 1 can be made from any convenient resilient material, for example metal, but in the construction being described they are formed from a suitable synthetic plastics material which has inherent resilience.

The mirror lens 2 is a resilient snap fit in the frame 3, the frame 3 being provided with one or more inner abutments 7 which are adapted to retain the mirror lens 2 in place. The upper rim 8 of the frame 3 projects inwardly so that when the mirror lens 2 is snapped into place it is retained between the inwardly projecting rim 8 and the inner abutments 7. The inner projecting face of the rim 8 can be seen most clearly in FIG. 6.

In the construction being described small slots 9 are provided at each corner of the frame which supply further resilience to the corners to assist assembly.

The casing is provided with a reinforced indented boss which is suitable adapted to receive a mounting (not shown). The mounting can be of any convenient type suitable to allow adjustment of the mirror when in place.

In the construction described above the mirror lens is convex but it could be concave, flat or any other convenient shape. The present construction is particularly suitable for use with mirror lens of the polycarbonate unbreakable type.

In order to assemble the construction it is merely necessary to press the mirror lens into place in the frame where it is retained by the abutments 7 and then press the frame into the housing or casing 1. The rear face of the mirror lens is protected and the frame can be removed from the casing by prising it out with a suitable instrument.

The present construction is light, easy to assemble and provides a rigid mounting for the mirror lens in the housing or casing 1.

1. A vehicle rear view mirror comprising a housing, a mirror lens and a location frame, said frame being adapted to carry said mirror lens and to locate within said housing.

2. A mirror as claimed in claim 1 in which said housing and said frame are releasably detachable.

3. A mirror as claimed in claim 2 in which said housing is provided with frame retainment means and said frame is provided with housing engagement means.

4. A mirror as claimed in claim 3 in which said frame retainment means comprises one or more catches and said housing engagement means comprises one or more abutments which co-operate with said catches.

5. A mirror as claimed in claim 4 in which said frame is a resilient snap fit in said housing.

6. A mirror as claimed in any of claims 1 to 5 in which said frame and said lens are releasably detachable.

7. A mirror as claimed in claim 6 in which said frame is provided with lens engagement means.

8. A mirror as claimed in claim 7 in which said lens engagement means comprises one or more abutments adapted to engage said lens.

9. A mirror as claimed in claim 8 in which said lens is a resilient snap fit in said frame.

10. A mirror as claimed in any of claims 1 to 9 in which said frame and/or said housing are made from a resilient synthetic plastics material.

11. A mirror as claimed in any of claims 1 to 10 in which said housing is provided with a rim portion within which said frame is located.

12. A mirror as claimed in any of claims 1 to 11 in which said housing comprises a casing adapted to cover the rear face of said lens.

13. A mirror as claimed in claim 12 in which said casing is provided with means to receive a mounting attached to said vehicle.

14. A mirror as claimed in claim 13 in which said lens is concave or convex or flat.

15. A mirror as claimed in claim 14 in which said lens is of the polycarbonate unbreakable type, or any other substrate on which a reflective surface may be deposited.

16. A mirror as claimed in claim 14 in which said lens is glass.

17. A mirror as claimed in any of claims 1 to 16 in which said frame is provided with slots at each corner to supply further resilience to said frame.
